(19) United States
(12) Patent Application Publication
(10) Pub. No.: US 2001/0048276 A1
(43) Pub. Date: Dec. 6, 2001

(54) Visual display

(75) Inventors: Ingemar V. Rodriguez, San Diego, CA (US); William P. Bischoff, San Marcos, CA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Complete Substrate Solutions Limited

(21) Appl. No.: 09/872,663

(22) Filed: Jun. 1, 2001

Related U.S. Application Data
(60) Provisional application No. 60/208,714, filed on Jun. 1, 2000.

(51) Int. Cl. G09G 3/10

(52) U.S. Cl. 315/160; 315/169.3; 315/169.4

(57) ABSTRACT

A display has a cathode 1 and an anode 2. These are in plate form and held spaced apart by a peripheral frame 3, to which they are both sealed. The cathode has an emission layer 11 deposited on a front ceramic layer 12 with vias 14 to the emission layer. The foundation layer is fired, ground flat and has via apertures cut through it and filled 17 prior to lamination of the front layer. Onto the back face of the substrate, preferably prior to deposition of the emission layer, is spun on a dielectric layer 21, which is developed with the aid of a temporary mask (not shown) to provide etchable tracks. These are etched to leave grooves 22 corresponding to metallic interconnections 23 from the foundation layer vias 17 to vias 24 in the next dielectric layer 25, typically thicker than the previous one 21. The metallic interconnections 23 are formed by screen printing and firing. Then another pair of dielectric layers 26, 27 is laid down, developed, etched and filled with interconnections 28 and vias 29 for connection to next vias. The process is continued to build four pairs of dielectric layers behind the foundation layer 16. In each successive layer, the vias are progressively spaced further apart and their arrangement organised so that they can make contact, via metallic pads 31 provided in like manner to the interconnection tracks, with driver chip contacts.

### FIELD OF THE INVENTION

The present invention relates to a visual display, particularly though not exclusively for use with data processing apparatus.

### BACKGROUND OF THE INVENTION

In prior International patent application, No. PCT/US98/20813, published on Apr. 8th 1999 under No. WO 99/17330 (“The Earlier International Application”), we described and claimed:

a field effect emission device for a visual display comprising:

a substrate and

an emission layer on one face of the substrate, the emission layer having:

a multiplicity of emitters and gates, arranged as an array of emission pixels and

conductive connections in the emission layer to the emitters and the gates;

the substrate having:

conductive vias provided through the substrate or at least a front layer thereof to at least some of the said conductive connections in the emission layer for electrical connection to their emitters and gates.

In this specification, we refer to the type of field emission device described in The Earlier International Application as the Front-Layer-Via FED Device.

We have now developed further both the device and the display incorporating the device.

### The Invention

According to the present invention there is provided there is provided a field emission device for a visual display comprising:

a substrate and

an emission layer on one face of the substrate, the emission layer having:

a multiplicity of emitters and gates, arranged as an array of emission pixels and

conductive connections in the emission layer to the emitters and the gates;

the substrate having:

conductive vias provided through the substrate or at least a front layer thereof to at least some of the said conductive connections in the emission layer for electrical connection to their emitters and gates

characterised in that the substrate includes:

at least one ceramic layer supporting the emission layer and having the front layer vias and

at least one deposited dielectric layer and at least one deposited metallic layer,

the deposited dielectric layer(s) providing via apertures therethrough and

the metallic layer(s) providing via connections across the dielectric layer(s) and interconnections between the vias in the adjoining layers.

Preferably:

vias in alternate deposited dielectric layers are progressively spaced further apart;

the device includes a back dielectric layer having deposited thereon metallic contact pads; and

the device includes an over-hanging, frangible portion of the cathode plate having secondary metallic contact pads connected to the metallic contact pads.

In The Earlier International Application, the front layer is described as having a number of other ceramic layers laminated thereto. Whilst this is a viable manner of building up a substrate—and remains our preferred manner for high volume production—for certain technical applications, in particular lower volume, the present invention provides flexibility to produce non-standard devices.

The dielectric and metallic layer can be formed by a variety of known methods, such as screen printing and vapour deposition. In so far as the methods are known in themselves they will not be described in great detail herein.

To help understanding of the invention, a specific embodiment thereof will now be described by way of example and with reference to the accompanying drawings, in which:

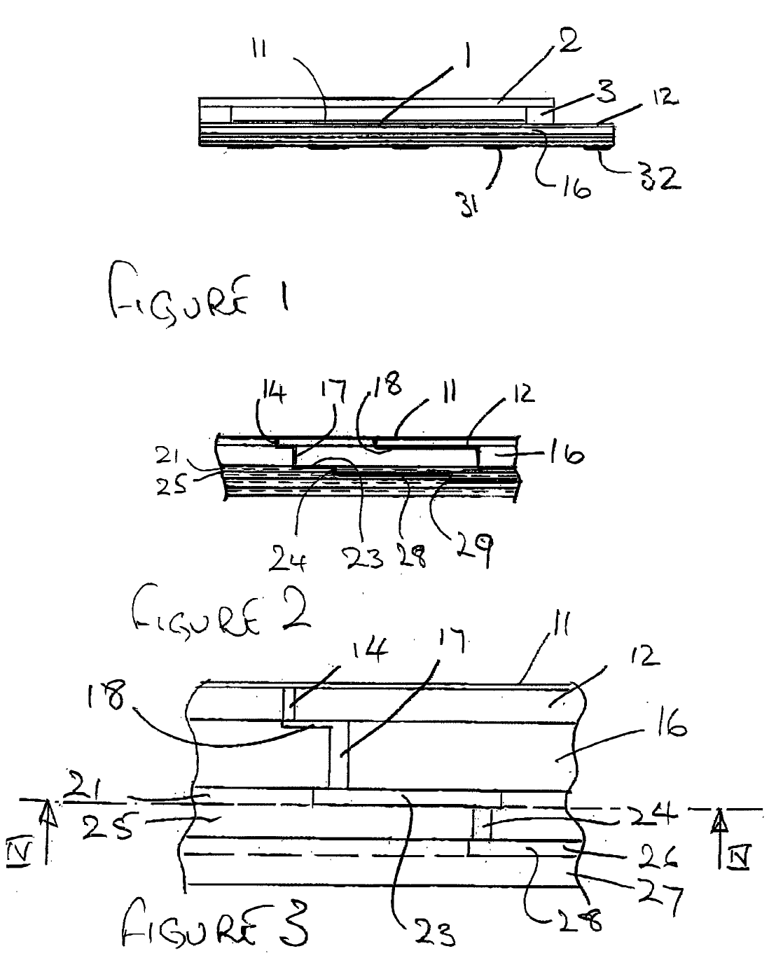

FIG. 1 is a diagrammatic cross-sectional view of an FED visual display according to the invention,

FIG. 2 is a scrap view in more detail of a portion a cathode plate of the display,

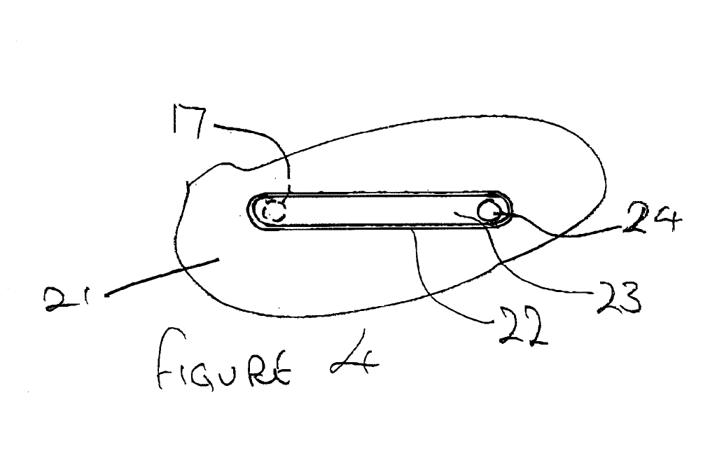

FIG. 3 is a similar scrap view on an even larger scale more detail,

FIG. 4 is a scrap underneath view on the line IV-IV in FIG. 3.

Referring first to FIGS. 1 & 2 of the drawings, the display has a cathode 1 and an anode 2. These are in plate form and held spaced apart by a peripheral frame 3, to which they are both sealed. The manner in which the sealing is effected can be as described in The Earlier International Application and will not be described in detail here.

The cathode is a Front Layer Via FED device in accordance with the invention. As such it has an emission layer 11 deposited on a front ceramic layer 12 with vias 14 to the emission layer. Typically, the front layer 12 is a thin layer with a thickness of 0,006″ laminated in the green state to a thicker foundation layer 16 with a thickness of 0.030″. The foundation layer will have been fired, ground flat and had via apertures cut through it and filled 17 prior to lamination of the front layer. The vias 14, 17 can align or interconnection tracks 18 can be provided at the interface between the layers as described in our co-pending US provisional patent application Ser. No, 60/208776, dated Jun. 1st 2000, (“The Co-pending Application”).

As particularly shown in FIGS. 3 & 4, onto the back face of the substrate, preferably prior to deposition of the emission layer, is spun on a dielectric layer 21, which is developed with the aid of a temporary mask (not shown) to provide etchable tracks. These are etched to leave grooves 22 corresponding to metallic interconnections 23 from the foundation layer vias 17 to vias 24 in the next dielectric layer 25, typically thicker than the previous one 21. The metallic interconnections 23 are formed by screen printing and firing. Then another pair of dielectric layers 26, 27 is laid down, developed, etched and filled with interconnections 28 and vias 29 for connection to next vias (not shown in FIG. 2). The process is continued to build four pairs of dielectric layers behind the foundation layer 16. In each successive layer, the vias are progressively spaced further apart and their arrangement organised so that they can make contact, via metallic pads 31 provided in like manner to the interconnection tracks, with driver chip contacts.

As shown, the cathode plate over-hangs the carrier, whereby alternative edge connections 32 can be used for testing the display prior to permanent connection of driver chips. The over hanging portion can be broken off after testing, to reduce the area of the cathode plate in use to that of the anode plate.

In the process just described, the vias and the interconnection tracks are laid down separately. This has the advantage of allowing different materials to be used for the vias and for the interconnection tracks. Thus as described in The Co-pending Application, the vias can be given a determined resistance. However, it does involve separate firings for the vias of each successive material of the layers, the vias and the interconnections. In an alternative, the vias and the interconnections are laid down together of the same material, by screen printing. This involves half the number of firings. Also half the number of dielectric layers are laid down, since these cover the tracks and are etched back to them at the via positions for this next layer.

The invention is not intended to be restricted to the details of the above described embodiment. For instance, the metallic interconnections and the vias can be provided laying down a continuous layer, filling vias in the dielectric layer on which it was laid. Next, it is etched away to leave tracks. Such a layer can be provided by screen printing or vacuum deposition.

1. A field emission device for a visual display comprising:
a substrate and
an emission layer on one face of the substrate, the emission layer having;
a multiplicity of emitters and gates, arranged as an array of emission pixels and
conductive connections in the emission layer to the emitters and the gates;
the substrate having:
conductive vias provided through the substrate or at least a front layer thereof to at least some of the said conductive connections in the emission layer for electrical connection to their emitters and gates
characterised in that the substrate includes:
at least one ceramic layer supporting the emission layer and having the front layer vias and
at least one deposited dielectric layer and at least one deposited metallic layer;
the deposited dielectric layer(s) providing via apertures therethrough and
the metallic layer(s) providing via connections across the dielectric layer(s) and interconnections between the vias in the adjoining layers.

2. A field emission device according to claim 1, wherein vias in alternate deposited dielectric layers are progressively spaced further apart.

3. A field emission device according to claim 2, including a back dielectric layer having deposited thereon metallic contact pads.

4. A field emission device according to claim 3, including an over-hanging, frangible portion of the cathode plate having secondary metallic contact pads connected to the metallic contact pads.
